(19) United States
(12) Patent Application Publication
(10) Pub. No.: US 2005/0220568 A1
(43) Pub. Date: Oct. 6, 2005

(54) Method and system for fastening components used in plasma processing

(75) Inventor: Steven T. Fink, Mesa, AZ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Minato-ku (JP)

(21) Appl. No.: 10/813,067

(22) Filed: Mar. 31, 2004

(51) Int. Cl. F16B 21/00

(52) U.S. Cl. 411/553

(57) ABSTRACT

A fastening component for fastening together a first component and a second component used in a plasma processing tool. The fastening component includes a first surface configured to be exposed to plasma processing performed in the plasma processing tool, and a second surface configured to contact the first component. Also included is a stem extending from the second surface and configured to at least partially protrude through the first component and the second component. The fastening component further includes a locking pin extending from at least one side of the stem and configured to contact the second component. The first surface, the second surface, the stem, and/or the locking pin are made of or coated with a material that is highly resistant to erosion resulting from plasma processing.

### BACKGROUND OF THE INVENTION

1. Field of the Invention

The present invention is generally related to plasma processing and, more particularly, to fastening hardware used in a plasma processing tool.

2. Discussion of the Background

The fabrication of integrated circuits typically employs plasma to create and assist surface chemistry within a processing chamber to remove material from, and deposit material to, a substrate. In general, plasma is formed with a plasma reactor under vacuum conditions by heating electrons to energies sufficient to sustain ionizing collisions with a supplied process gas. Moreover, the heated electrons can have energy sufficient to sustain dissociative collisions. Therefore, a specific set of gases under predetermined conditions (e.g., chamber pressure, gas flow rate, etc.) are chosen to produce a population of charged species and chemically-reactive species suitable to the particular process being performed within the processing chamber. Examples of plasma processes include etching, in which materials are removed from a substrate, or deposition, in which materials are added to the substrate.

Although the formation of a population of charged species and chemically-reactive species is necessary to perform functions of the plasma processing tool at the substrate surface, other component surfaces in the processing chamber are exposed to the physically and chemically active plasma. In time, these surfaces can erode and release contaminating materials into the processing chamber. Such releases lead to a gradual degradation of plasma processing performance and, ultimately, to complete failure of the system.

To minimize the erosion of components in a processing chamber, susceptible component surfaces, such as exposed surfaces of fastening hardware, can be protected from exposure to plasma by shielding components. For example, FIG. 5 illustrates two components 60 and 62 used in a plasma processing chamber. The component 60 can represent an inject plate, for example, and the component 62 can represent a bottom plate of an upper electrode. The component 60 is fastened to the component 62 by a threaded fastener 64 and a mating component 66. The fastener 64 is made of aluminum or some other material that erodes after exposure to plasma processes and that can subsequently contaminate a substrate being process. To prevent or reduce such erosion and contamination, a shielding component 68 is used. The shielding component 68 is made of, or is coated with, a material that is highly resistant to the eroding effects of plasma, but such components are expensive to produce and result in extra parts to maintain in a plasma processing tool.

### BRIEF SUMMARY OF THE INVENTION

Accordingly, the present invention advantageously provides a method and system for fastening components used in plasma processing without the use of shielding components. By eliminating or reducing component erosion, and by reducing the quantity of components needed to perform contamination-free processing, the present invention provides for simpler and less expensive plasma processing.

In accordance with an aspect of the present invention, a fastening component is provided for fastening together a first component and a second component used in a plasma processing tool. The fastening component includes a first surface configured to be exposed to plasma processing performed in the plasma processing tool, and a second surface configured to contact the first component. Also included is a stem extending from the second surface and configured to at least partially protrude through the first component and the second component. The fastening component further includes a locking pin extending from at least one side of the stem and configured to contact the second component. The first surface, the second surface, the stem, and/or the locking pin are made of or coated with a material that is highly resistant to erosion resulting from plasma processing.

In accordance with another aspect of the present invention, a fastening system is provided for fastening a first object to a second object. The fastening system includes a first fastening component including a first contacting surface configured to contact the first object, a stem extending from the first surface, and a locking pin extending from at least one side of the stem. The fastening system also includes a second fastening component including a hole, a fastening surface configured to contact the locking pin, and a second contacting surface configured to contact the second object. The stem, the locking pin, and the hole are configured such that the first object and the second object are fastened to each other when the locking pin protrudes through first object, the second object, and the hole, and when the stem is rotated such that the locking pin contacts a locking area of the fastening surface.

In accordance with a further aspect of the present invention, a method is provided for fastening a first object to a second object, where the first object and the second object are used in a plasma processing tool. The method includes providing a fastening component with an exterior surface made out of a material that is highly resistant to erosion resulting from plasma processing, where the fastening component includes a first surface, a stem extending from the first surface, and a locking pin extending from at least one side of the stem. The method also includes inserting the stem and the locking pin through the first object and the second object. Also included is a step of rotating the stem such that the locking pin contacts a second surface of the second object and such that the first object and the second object are fastened between the locking pin and the first surface.

In accordance with yet another aspect of the present invention, a method is provided for fastening a first object to a second object with a first fastening component and a second fastening component. The method includes inserting the first fastening component through the first object, through at least a portion of the second object, and through the second fastening component. The method also includes rotating the first fastening component less than a full rotation such that the first fastening component contacts an outer surface of the second fastening component and such that the first object and the second object are fastened to each other.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a detailed, section view of a fastener and processing objects in accordance with an aspect of the present invention.

FIG. 2 is an exploded view of the fastener and the processing objects shown in FIG. 1.

FIG. 3 is a detailed, section view of a fastener system and processing objects in accordance with another aspect of the present invention.

FIG. 4 is an exploded view of the fastener system and the processing objects shown in FIG. 3.

FIG. 5 is a detailed, section view of a known fastener and shielding component.

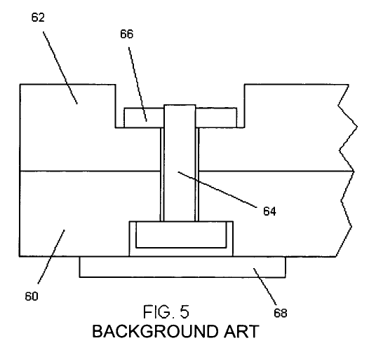

### DETAILED DESCRIPTION OF THE INVENTION

Referring now to the drawings, where like reference numeral designations identify the same or corresponding parts throughout the several views, several embodiments of the present invention are next described.

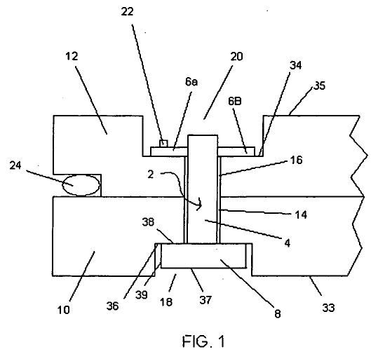

FIG. 1 illustrates an object 10 and an object 12 being fastened together by a fastener 2 according to an aspect of the present invention. The object 10 can represent an inject plate or any other component used in plasma processing that is exposed to plasma. The object 12 can represent a bottom plate of an upper electrode or any other component that is fastened to the object 10. Although objects 10 and 12 are shown as flat plates, they can alternatively be of any other shape. Moreover, while objects 10 and 12 are respectively shown to include recessed portions 18 and 20, objects 10 and 12 can be alternatively configured such that surface 36 is flush with surface 33 and such that surface 34 is flush with surface 35, respectively.

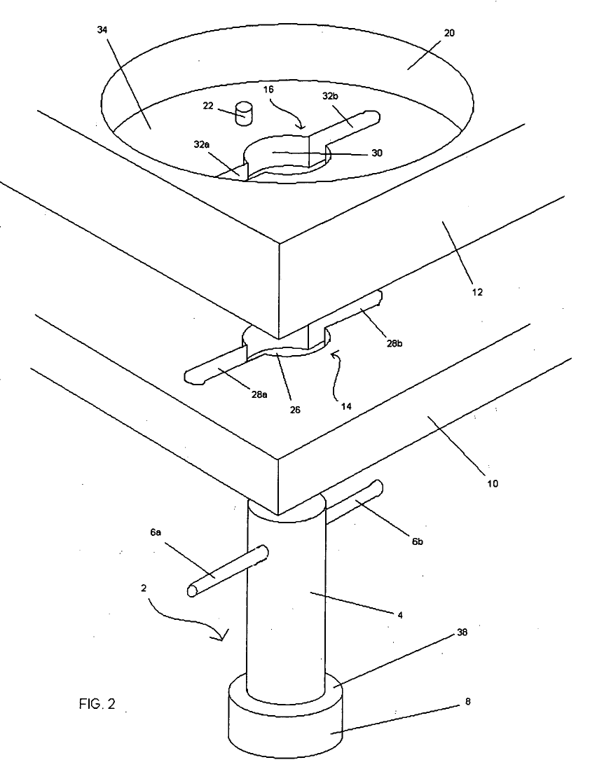

The object 10 is provided with a hole 14, and the object 12 is provided with a hole 16. As shown in FIG. 2, the hole 14 includes a center portion 26 and slots 28a and 28b. Likewise, the hole 16 includes a center portion 30 and slots 32a and 32b. The slots 28a, 28b, 32a, and 32b are shown on opposite sides of their respective center portions, but can alternatively be positioned at different angles about their center portions, depending the arrangement of a pin 6, described below. Also, alternative to the configurations shown in FIGS. 1 and 2, the holes 14 and 16 can each include only one slot portion or more than two slot portions. Moreover, the slots 28a, 28b, 32a, and 32b can be of any shape other than shown in FIG. 2, depending on the corresponding shape of the pin 6.

The fastener 2 includes a head 8 including a contacting surface 38 and exposed surfaces 37 and 39. As exposed surface 37 and 39 are arranged to be exposed to plasma processing, the head 8 is either made of or coated with a material that is highly resistant to erosion resulting from plasma processing. Further, the material is such that erosion of the material does not contaminate a substrate being processed in a plasma processing chamber. Examples of materials that meet these criteria are anodized aluminum, polyimide (such as Vespel), silicon, quartz, and ceramic. Examples of ceramic coating materials are discussed in U.S. patent application Ser. No. 10/764,456, filed Jan. 27, 2004, the entire contents of which are incorporated herein by reference. The head 8, or the material that coats the head 8, can be made of one or more of these materials or any other materials or material combinations that exhibit the above-described characteristics. The attachment and manufacture of hybrid fasteners, e.g., by pinning and brazing methods, is discussed in U.S. patent application Ser. No. 60/466,416, filed Apr. 30, 2003, the entire contents of which are incorporated herein by reference. The head 8 is shown in FIG. 2 to have a circular outer surface, but can alternatively have any other outer geometry that allows rotation by human fingers or tools. The head 8 can also include an inner recess that is configured to engage with a rotating tool.

The head 8 includes a stem 4 that extends from the contacting surface 38, which is arranged to contact the surface 36 when the object 10 is fastened to the object 12. The stem 4 can be a portion integrally manufactured with the head 8, or can be attached to the head 8 in a post-forming process. Also, the stem 4 is made of the same material as the head 8 or, alternatively, can be made of any other material that possesses characteristics necessary to withstand the loads created by use of the fastener 2 and the conditions created by plasma processing. The stem 4 can be coated with a plasma-resistant material, as described above, or can be uncoated. The stem 4 is arranged to protrude through both holes 14 and 16 and beyond the surface 34, and can be circular in cross-section, as shown in FIG. 2, or can alternatively be of any other cross-sectional shape that allows rotation within the holes 14 and 16.

The fastener 2 includes the pin 6, which extends from opposite sides of the stem 4 as pin portions 6a and 6b. Alternatively, the pin 6 can extend from only one side of the stem 4 or from more than two sides. The pin 6 is shown as a cylindrically-shaped component, but can alternatively be of any shape or cross-section. The pin 6 can be made of or coated with a plasma-resistant material, as described above, or any other material strong enough withstand expected loads (e.g., a spring load caused by an elastic element 24, as described below). The pin 6 can be arranged as a single component that is attached to the stem by an interference fit, brazing, or any other method of attaching that is suitable for the expected loads. Alternatively, the pin portions 6a and 6b can exist as independent elements that are separately attached to the stem by one of the above-mentioned methods. Also, as a further alternative, the pin 6 can be integrally manufactured with the stem 4 and/or the head 8. For example, the pin 6, the stem 4, and the head 8 can be machined as a single, integral component.

To fasten the object 10 to the object 12, the stem 4 and the pin 6 are first inserted through the hole 14. Due to the configuration of slots 28a and 28b and of the pin portions 6a and 6b, the fastener 2 can only be inserted one of two ways (i.e., pin portion 6a in slot 28a or 28b). After the pin 6 protrudes through the object 10, it enters the hole 16, where the configuration of slots 32a and 32b govern the position of the pin 6. After the pin 6 protrudes through the object 12, the stem 4 is rotated by rotation of the head (e.g., by hand or by a tool) such that the pin 6 contacts the surface 34 surrounding the hole 16. The length of the stem 4 and the position of the pin 6 are configured such that the object 10 is clamped to the object 12 between the pin 6 and the surface 38 when the pin 6 contacts a portion of the surface 34. For example, the distance between a contacting portion of the pin 6 and the surface 38 can be equal to or greater than (e.g., for a clearance fit) the distance between the surface 34 and the surface 36 when the object 10 is brought into contact with the object 12. Thus, complete separation between the object 10 and the object 12 is prevented by the fastener 2. The object 10 and the object 12 are unfastened by rotating the stem 4 such that pin portions 6a and 6b align with slots 32a and 32b and by removing the fastener 2.

To prevent full rotation of the stem 4, a restricting element 22 is provided on the surface 34 to contact and restrict the movement of the pin 6. The restricting element 22 is arranged as a pin extending from the surface 34, but can alternatively be any other means for restricting rotation of the stem 4.

Further, to ensure that the object 10 is tightly fastened to the object 12, an elastic element 24 is positioned between the object 10 and the object 12. The elastic element 24 can be arranged as a spira-shield component or as any other biasing component, such as a coil spring or o-ring. When the fastener 2 is attached to the object 10 and the object 12 as described above, the elastic element 24 is an a compressed state and creates a spring load forcing the object 10 into the surface 38 and forcing the object 12 into the pin 6. The elastic element 24 can be alternatively placed between the surface 38 and the surface 36 or between the pin 6 and the surface 34. Moreover, the elastic element 24 can be electrically conductive, such that it can be used as a grounding device.

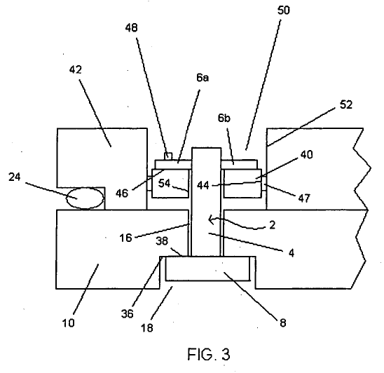

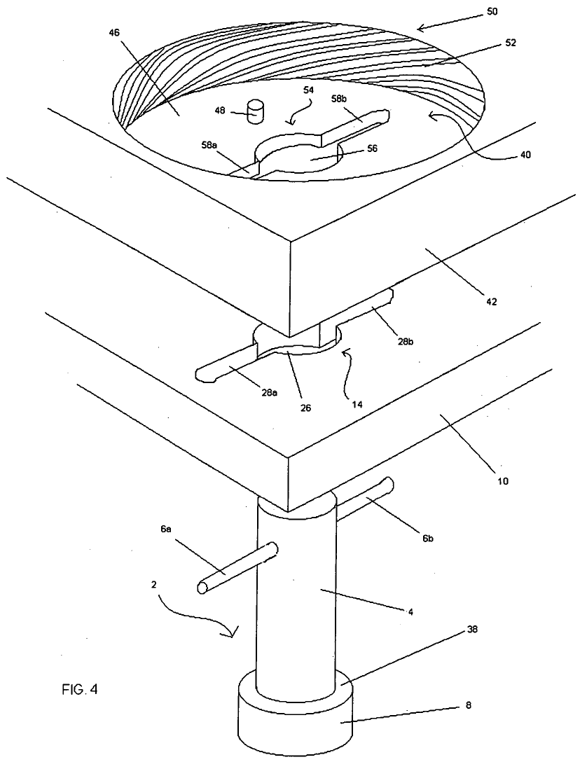

FIGS. 3 and 4 depict another aspect of the present invention, in which the object 10 is fastened to an object 42 by the fastener 2 and a fastening component 40. In this aspect, the object 42 includes an opening 50, which can be a full bore through the thickness of the object 42, as shown in FIGS. 3 and 4, or a recessed portion of the object 42. The opening 50 is sized to accommodate the outer diameter of the fastening component 40 and includes a threaded surface 52 that corresponds to the outer diameter of a locking helical coil 47 positioned in the threaded surface 52 of the object 42 or, alternatively, to a threaded portion 44 of the fastening component 40. In this way, the fastening component 40 can be translated along the surface 52 by rotation of the fastening component 40 within the opening 50. Alternative to the use of threaded surfaces, the fastening component 40 can also be translatable along the surface 52 by any other adjustable means. Translation of the fastening component 40 within the opening 50 can be restricted or prevented by the use of the locking helical coil 47 or by any other restricting means known in the art.

Similarly to the object 12 in FIGS. 1 and 2, the fastening component 40 includes a hole 54 having a center portion 56 and slots 58 and 58b configured to receive the stem 4 and the pin 6. The fastening component 40 also includes a restricting pin 48 to prevent full rotation of the stem 4 once the pin 6 is positioned above the surface 46. The thickness of the fastening component 40 is such that the fastening component 40 can be moved within the opening 50 to allow a range of distances between the surface 46 and the surface 36. The fastening component 40 can be made of the same material as the fastener 2 or a portion of the fastener 2. Alternatively, the fastening component 40 can be made of any formable material that is suitable for the described functions of the fastening component 40. Moreover, if the fastening component 40 is exposed to plasma during operation of a plasma processing tool, the fastening component 40 can be at least partially made of or coated with a plasma-resistant material, as discussed above.

To fasten the object 10 to the object 42, the stem 4 and the pin 6 are first inserted through the hole 14 and then through the hole 54. The stem 4 is then rotated by rotation of the head 8 such that the pin 6 contacts the surface 46 and such that the object 42, which is attached to the fastening component 40 by threaded portions 52 and 44 or via the helical coil 47, is fastened to the object 10 by a fastening force. The fastening force can be adjusted by changing the position of the fastening component 40 within the opening 50 before insertion of the pin 6 through the hole 54. The elastic element 24 can also be used in this aspect to create a spring load between the object 10 and the object 42.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A plasma processing tool comprising:
a process chamber;
first and second components positioned within the process chamber; and
a fastening component configured to fasten said first and second components together, said fastening component comprising:
a first surface configured to be exposed to plasma processing performed in the plasma processing tool;
a second surface configured to contact the first component;
a stem extending from the second surface and configured to at least partially protrude through the first component and the second component; and
a locking pin extending from at least one side of the stem and configured to contact the second component such that the first and second components are fastened together between the second surface and locking pin,
wherein at least one of the first surface, the second surface, the stem, and the locking pin is at least one of made of and coated with a material that is highly resistant to erosion resulting from plasma processing, and
wherein said fastening component is not shielded from said plasma by a plasma shield component.

2. The fastening component of claim 1, wherein the material is at least one of anodized aluminum, polyimide, silicon, quartz, and ceramic.

3. The fastening component of claim 1, wherein the material is a combination of at least two of anodized aluminum, polyimide, silicon, quartz, and ceramic.

4. The fastening component of claim 1, wherein a cross-section of the stem is smaller than the second surface.

5. The fastening component of claim 1, wherein a longitudinal axis of the locking pin is orthogonal to a longitudinal axis of the stem.

6. The fastening component of claim 1, wherein the locking pin is attached to the stem by an interference fit.

7. The fastening component of claim 1, wherein the locking pin is attached to the stem by brazing.

8. A plasma processing tool comprising:
a process chamber;
first and second process chamber objects positioned within the process chamber;
a fastening system for fastening the first object to the second object, the fastening system comprising:
a first fastening component including a first contacting surface configured to contact the first object, a stem extending from the first surface, and a locking pin extending from at least one side of the stem; and
a second fastening component including a hole, a fastening surface configured to contact the locking pin, and a second contacting surface configured to contact the second object,
wherein the stem, the locking pin, and the hole are configured such that the first object and the second object are fastened to each other when:
the locking pin protrudes through first object, the second object, and the hole, and the stem is rotated such that the locking pin contacts a locking area of the fastening surface, and
wherein said fastening components are not shielded from said plasma by a plasma shield component.

9. The fastening system of claim 8, wherein the second contacting surface is configured to be movable relative to the second object to change a fastening force between the first object and the second object.

10. The fastening system of claim 9, wherein the second contacting surface includes a first threaded surface, and the second object includes a second threaded surface configured to engage with the first threaded surface.

11. The fastening system of claim 9, wherein the second fastening component is configured to be inserted into an opening of the second object.

12. The fastening component of claim 8, wherein a longitudinal axis of the locking pin is orthogonal to a longitudinal axis of the stem.

13. The fastening component of claim 8, wherein the locking pin is attached to the stem by an interference fit.

14. The fastening component of claim 8, wherein the locking pin is attached to the stem by brazing.

15. The fastening component of claim 8, wherein the hole includes a first portion shaped to receive the stem and a second portion shaped to receive the locking pin.

16. The fastening component of claim 8, wherein the second fastening component includes a restricting element provided at the fastening surface and configured to restrict rotation of the stem.

17. The fastening component of claim 16, wherein the restricting element is a pin attached to the fastening surface.

18. The fastening system of claim 8, further comprising:
a locking element configured to restrict movement between the second contacting surface and the second object.

19. The fastening system of claim 18, wherein the locking element includes a helical coil.

20. The fastening system of claim 8, wherein at least a portion of the first fastening component is at least one of made of and coated with a material that is highly resistant to erosion resulting from plasma processing.

21. The fastening component of claim 20, wherein the material is at least one of anodized aluminum, polyimide, silicon, quartz, and ceramic.

22. The fastening component of claim 20, wherein the material is a combination of at least two of anodized aluminum, polyimide, silicon, quartz, and ceramic.

23. A method for fastening a first plasma process chamber object to a second plasma process chamber object, comprising:
providing a fastening component with an exterior surface made out of a material that is highly resistant to erosion resulting from plasma processing, wherein the fastening component includes a first surface, a stem extending from the first surface, and a locking pin extending from at least one side of the stem, and is not shielded by a plasma shield for shielding the fastening component from a plasma within said process chamber;
inserting the stem and the locking pin through the first object and the second object; and
rotating the stem such that the locking pin contacts a second surface of the second object and such that the first object and the second object are fastened between the locking pin and the first surface.

24. The method of claim 23, wherein the providing step includes at least one of making or coating at least a portion of the fastening component with at least one of anodized aluminum, polyimide, silicon, quartz, and ceramic.

25. The method of claim 23, wherein the providing step includes at least one of making or coating at least a portion of the fastening component with a combination of at least two of anodized aluminum, polyimide, silicon, quartz, and ceramic.

26. The method of claim 23, further comprising:
positioning a stopping element at the second object to restrict rotation of the stem after the stem and the locking pin are inserted through the first object and the second object.

27. The method of claim 23, further comprising:
positioning an elastic element between the first surface and the first object or between the first object and the second object such that the rotating step creates a spring load between the first object and the second object.

28. The method of claim 27, wherein the elastic element is electrically conductive.

29. The method of claim 23, further comprising:
providing the second object with a hole including a first portion shaped to receive the stem and a second portion shaped to receive the locking pin.

30. A method for fastening a first plasma process chamber object to a second plasma process chamber object with a first fastening component and a second fastening component, comprising:
inserting the first fastening component through the first object, through at least a portion of the second object, and through the second fastening component;
rotating the first fastening component less than a full rotation such that the first fastening component contacts an outer surface of the second fastening component and such that the first object and the second object are fastened to each other, with at least one of the first fastening component and the second fastening component not shielded by a plasma shield; and
at least one of manufacturing and coating said at least one of the first fastening component and the second fastening component with a material that is highly resistant to erosion resulting from plasma processing.

31. The method of claim 30, further comprising:
providing the first fastening component with a stem and a locking pin extending from the stem.

32. The method of claim 31, wherein the rotating step includes:
rotating the stem such that the locking pin contacts the outer surface.

33. The method of claim 30, further comprising:
positioning a restricting element at the second fastening component to prevent full rotation of the first fastening component when the first fastening component protrudes through the second fastening component.

34. The method of claim 30, further comprising:
providing the second object with a hole; and
inserting at least a portion of the second fastening component into the hole.

35. The method of claim 34, wherein,
the portion of the second fastening component includes a first threaded surface and the hole includes a second threaded surface corresponding to the first threaded surface.

36. The method of claim 34, further comprising:
adjusting the position of the second fastening component within the hole to change a fastening force between the first object and the second object.

37. (canceled)

38. The method of claim 37, wherein the material is at least one of anodized aluminum, polyimide, silicon, quartz, and ceramic.

39. The method of claim 37, wherein the material is a combination of at least two of anodized aluminum, polyimide, silicon, quartz, and ceramic.

40. The method of claim 30, further comprising:
positioning an elastic element between the first object and the second object such that the rotating step creates a spring load between the first object and the second object.

41. The method of claim 30, further comprising:
positioning an elastic element between the first fastening component and the first object such that the rotating step creates a spring load between the first object and the second object.

42. The method of claim 30, further comprising:
positioning an elastic element between the second fastening component and the second object such that the rotating step creates a spring load between the first object and the second object.

43. The method of claim 40, wherein the elastic element is electrically conductive.

44. The plasma processing tool of claim 1, wherein said first component comprises a bottom plate of an upper electrode and said second component comprises a gas inject plate.

45. The plasma processing tool of claim 8, wherein said first process chamber object comprises a bottom plate of an upper electrode, and said second process chamber object comprises a gas inject plate.

46. The method of claim 23, wherein said first process chamber object comprises a bottom plate of an upper electrode and said second process chamber object comprises a gas inject plate.

47. The method of claim 30, wherein said first plasma process chamber object comprises a bottom plate of an upper electrode and said second plasma process chamber object comprises a gas inject plate.
